(19) United States
(12) Patent Application Publication
(10) Pub. No.: US 2007/0012769 A1
(43) Pub. Date: Jan. 18, 2007

(54) Printing apparatus, information management apparatus, print processing method and computer program product

(75) Inventor: Kei Tanaka, Tokyo (JP)

Correspondence Address: MORGAN LEWIS & BOCKIUS LLP, 1111 PENNSYLVANIA AVENUE NW, WASHINGTON, DC, 20004, US

(73) Assignee: FUJI XEROX CO., LTD.

(21) Appl. No.: 11/292,000

(22) Filed: Dec. 2, 2005

(30) Foreign Application Priority Data
Jul. 12, 2005 (JP) P2005-203133

(51) Int. Cl. G06F 15/12; G06F 17/00

(52) U.S. Cl. 235/432; 235/375

(57) ABSTRACT

A printing apparatus comprises an electronic document acquisition part that acquires an electronic document of a print target, a code information generation part that generates code information for uniquely identifying a medium on which a document image of the electronic document is printed, a code image generation part that generates a code image for printing from the code information generated by the code information generation part, a document image generation part that generates the document image from the electronic document, a printing part that prints the generated code image and the document image on the medium, and a management part that associates at least one of information obtained in a case of acquiring the electronic document and information obtained in a case of printing the electronic document with the code information and managing the information.

### BACKGROUND OF THE INVENTION

1. Field of the Invention

The present invention relates to a printing apparatus such as a copying machine or a printer, and an information management apparatus etc. for managing various information about printing etc. in this printing apparatus.

2. Description of the Related Art

A related art in which a character or a picture is drawn on special paper on which fine dots are printed and a user transmits data such as the character written on this paper to a personal computer or a cellular telephone, etc. and mail sending or retention of the contents of this data can be performed has received attention in recent years. The related art is constructed so that small dots are printed on this special paper at a spacing of, for example, about 0.3 mm and all the dots draw different patterns every grid of, for example, a predetermined size. By reading this using a dedicated pen into which, for example, a digital camera is built, a position of the character etc. written on this special paper can be pinpointed and such a character etc. can be used as electronic information.

Here, in the related art, an electronic document is associated with paper on which its electronic document is printed and a character etc. written on the paper that are merged with the electronic document. Specifically, identification information about a page of the electronic document and information about a position on the paper are embedded in a code image typified by a machine-readable two-dimensional code etc. and are superimposed on the electronic document and are printed by a printer etc. Next, actions of writing into a printed document and a partial image of a writing place are continuously acquired from the printed document using a pen type scanner. Then, the identification information about the page of the electronic document and information about plural positions on the printed document of the partial image are detected by analyzing the acquired image. Thereafter, the page of the original electronic document is identified by the detected identification information and also the contents written on the printed document are reproduced by the information about plural positions and thereby, the written contents can be added to the page of the original electronic document.

### SUMMARY OF THE INVENTION

According to the related art, the electronic document can be associated with a medium such as the paper. However, in the related art, the identification information about the page of the electronic document is embedded in the medium as described above. Therefore, for example, when plural copies of the page of the same electronic document are printed, there was a problem that all the media of these plural copies have the same identification information and the media of the plural copies cannot be managed individually.

According to the related art, by specifying a position on the medium, the corresponding position of the original electronic document can be pinpointed. However, since various information about the electronic document or various information obtained in the case of printing the electronic document is not managed, there was a problem that such information cannot be traced.

For example, information etc. as to who has ever created the original electronic document of a document image printed on the medium in my hand or who has printed its document image at first may become necessary, but such information cannot be obtained in the case of the related art.

The present invention has been made in view of the above circumstances and provides a printing apparatus.

According to an aspect of the invention, a printing apparatus includes: an electronic document acquisition part that acquires an electronic document of a print target; a code information generation part that generates code information for uniquely identifying a medium on which a document image of the electronic document is printed; a code image generation part that generates a code image for printing from the code information generated by the code information generation part; a document image generation part that generates the document image from the electronic document; a printing part that prints the generated code image and the document image on the medium; and a management part that associates at least one of information obtained in a case of acquiring the electronic document and information obtained in a case of printing the electronic document with the code information and managing the information.

According to another aspect of the invention, an information management apparatus includes: a receiving part that receives instruction to print in a terminal apparatus of an electronic document; a code information generation part that generates code information that uniquely identifies a medium on which a document image of the electronic document is printed; a code image generation part that generates a code image that prints from the code information generated by the code information generation part; a document image generation part that generates the document image from the electronic document; a sending part that sends instruction to print the generated code image and the document image on the medium to a printing apparatus; and a management part that associates at least one of information obtained in a case of acquiring the electronic document and information obtained in a case of printing the electronic document with the code information and managing the information.

According to another aspect of the invention, a print processing method including: giving instruction to print an electronic document; generating code information that uniquely identifies a medium on which a document image of the electronic document is printed; generating a code image that prints from the generated code information; generating the document image from the electronic document; printing the generated code image and the document image on the medium; and associating at least one of information obtained in a case of acquiring the electronic document and information obtained in a case of printing the electronic document with the code information and managing the information.

According to another aspect of the invention, a storage medium readable by a computer, the storage medium storing a program of instructions executable by the computer to perform a function, including: receiving instructions to print an electronic document; generating code information that uniquely identifies a medium on which a document image of the electronic document is printed; generating a code image that prints from the generated code information; generating the document image from the electronic document; sending instruction to print the generated code image and the document image on the medium; and associating at least one of information obtained in the case of acquiring the electronic document and information obtained in the case of printing the electronic document with the code information and managing the information.

### BRIEF DESCRIPTION OF THE DRAWINGS

Embodiments of the invention will be described in detail based on the following figures, wherein:

FIG. 1 is a diagram showing the whole configuration of a system to which an embodiment of the invention is applied;

FIG. 2 is a block diagram showing a functional configuration of an identification information management server in the embodiment;

FIG. 3 is a flowchart showing an action related to registration of information about print instructions of the identification information management server in the embodiment;

FIG. 4 is a diagram showing a functional configuration of a control part of an image formation apparatus in the embodiment;

FIG. 5 is a flowchart showing an action of the control part of the image formation apparatus in the embodiment;

FIG. 6 is a diagram showing a configuration example of the image formation apparatus in the embodiment of the invention;

FIG. 7 is a flowchart showing an action related to registration of information about printing of the identification information management server in the embodiment;

FIG. 8 is a diagram showing an example of the contents of a correspondence information DB in the embodiment; and

FIG. 9 is a diagram showing another configuration of a system according to the embodiment.

### DESCRIPTION OF THE EMBODIMENTS

Embodiments of the invention will be described below in detail with reference to the accompanying drawings.

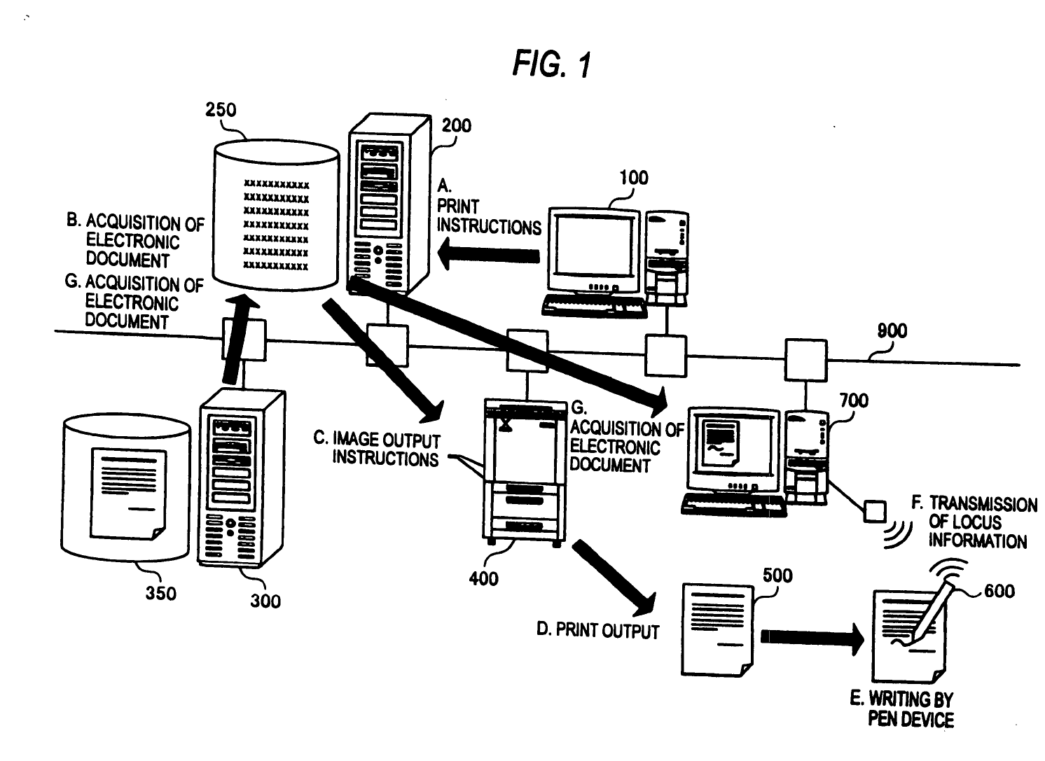

FIG. 1 shows one example of a configuration of a system to which the present embodiment is applied. At least a terminal apparatus 100 for instructing print of an electronic document, an identification information management server 200 for managing identification information given to a medium in the case of printing the electronic document and generating an image in which a code image including this identification information etc. is superimposed on an image of the electronic document, a document management server 300 for managing the electronic document and an image formation apparatus 400 for printing the image in which the code image is superimposed on the image of the electronic document are connected to a network 900 and thereby this system is configured.

Also, an identification information repository 250 acting as a storage device for storing the identification information is connected to the identification information management server 200, and a document repository 350 acting as a storage device for storing the electronic document is connected to the document management server 300.

Further, this system includes printed matter 500 outputted in the image formation apparatus 400 by instructions from the terminal apparatus 100, and a pen device 600 for recording a character or a figure on the printed matter 500 and reading recorded information about the character or the figure. Also, a terminal apparatus 700 for superimposing and displaying the electronic document managed in the document management server 300 and the recorded information read by the pen device 600 is connected to the network 900.

Incidentally, in the present specification, wording of an “electronic document” is used, but this does not refer to only data in which a “document” including text is computerized. For example, image data (which does not depend on raster data or vector data) such as a picture, a photograph or a figure, and other printable electronic data are also included to form the “electronic document”.

An outline of an action of the present system will be described below.

First, the terminal apparatus 100 instructs the identification information management server 200 to superimpose a code image on an image of an electronic document managed in the document repository 350 and do printing (A). At this time, print attributes such as a paper size, a direction, scaling, N-up (printing for allocating N pages of electronic documents inside one page of paper) or double-sided printing are also inputted from the terminal apparatus 100.

As a result of this, the identification information management server 200 acquires the electronic document whose printing is instructed from the document management server 300 (B). Then, a code image including position information decided according to the print attributes and identification information managed in the identification information repository 250 is given to an image of the acquired electronic document and the image formation apparatus 400 is instructed to print its image (C). Incidentally, here, the identification information refers to information for uniquely identifying individual media (papers) on which the image of the electronic document is printed, and the position information refers to information for pinpointing coordinate positions (X coordinate, Y coordinate) on the individual media.

Thereafter, the image formation apparatus 400 outputs the printed matter 500 according to instructions from the identification information management server 200 (D).

Incidentally, though description will be made later in detail, the image formation apparatus 400 shall form the code image given in the identification information management server 200 as an invisible image by invisible toner and form the other images (images of a portion included in the original electronic document) as visible images by visible toner.

On the other hand, it is assumed that a user records (writes) a character or a figure on the printed matter 500 using the pen device 600 (E). As a result of this, an image pickup device of the pen device 600 captures a certain area on the printed matter 500 and obtains the position information and the identification information. Then, the identification information and locus information of the character or the figure obtained based on the position information are transmitted to the terminal apparatus 700 by wireless or wire (F). Incidentally, in the system, an invisible image can be formed using invisible toner in which an absorption factor of infrared light is higher than a predetermined criterion and the invisible image can be read by the pen device 600 capable of detection and radiation of the infrared light.

Thereafter, the terminal apparatus 700 sends identification information to the identification information management server 200 and thereby, requests sending of an electronic document corresponding to this identification information. When this request is received, the identification information management server 200 acquires the electronic document corresponding to the identification information from the document management server 300 and sends the electronic document to the terminal apparatus 700 (G). As a result of that, the electronic document sent from the identification information management server 200 and the locus information sent from the pen device 600 are combined and displayed in the terminal apparatus 700.

However, such a configuration is merely one example. For example, one server may be configured to have a function of the identification information management server 200 and a function of the document management server 300. Also, a function of the identification information management server 200 may be implemented by an image processing part of the image formation apparatus 400. Further, the terminal apparatus 100 and 700 may be the same terminal apparatus.

Next, a configuration and an action of the system will be described in further detail.

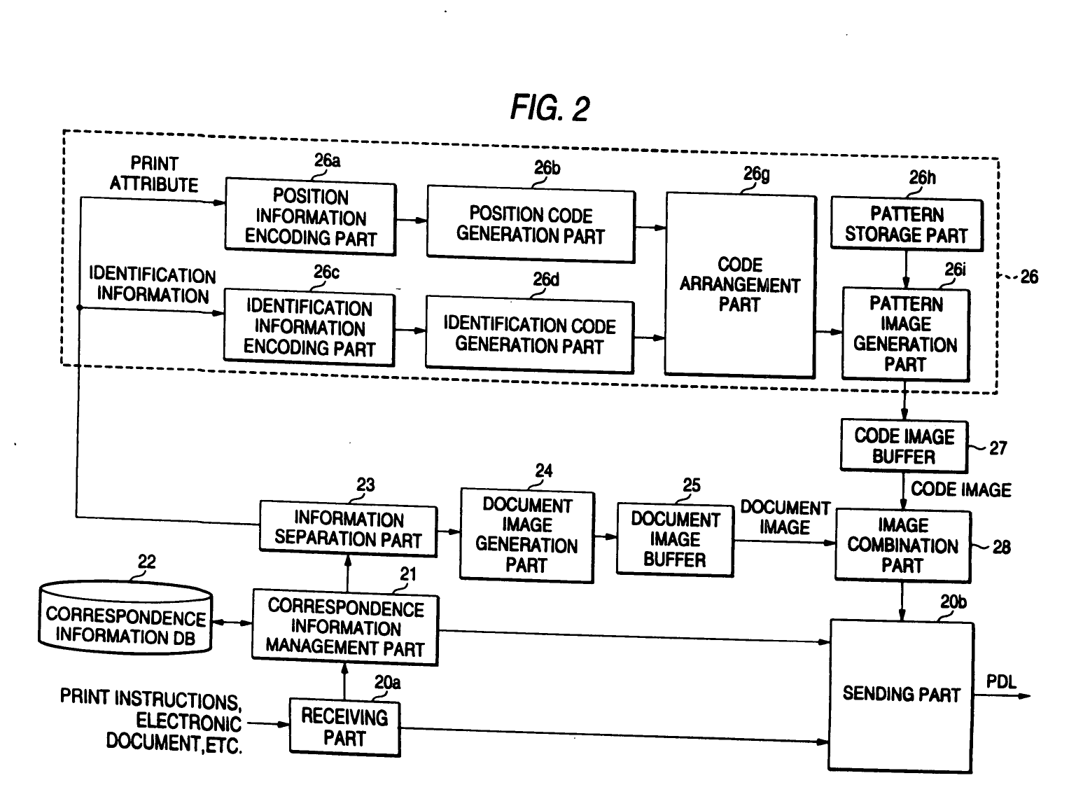

FIG. 2 is a diagram showing one example of a configuration of the identification information management server 200.

The identification information management server 200 comprises a receiving part 20a, a correspondence information management part 21, a correspondence information database (DB) 22, an information separation part 23, a document image generation part 24, a document image buffer 25, a code image generation part 26, a code image buffer 27, an image combination part 28 and a sending part 20b.

Also, the code image generation part 26 comprises a position information encoding part 26a, a position code generation part 26b, an identification information encoding part 26c, an identification code generation part 26d, a code arrangement part 26g, a pattern storage part 26h and a pattern image generation part 26i.

The receiving part 20a receives various information about instructions to print, an electronic document of a print target, etc. from the network 900. Incidentally, this receiving part 20a can also be grasped as an electronic document acquisition part from the standpoint of acquiring an electronic document.

The correspondence information management part 21 registers information in the correspondence information DB 22 and reads information out of the correspondence information DB 22. The correspondence information DB 22 is a database for storing correspondence of identification information (hereinafter called “a medium ID”) for identifying a medium, identification information (hereinafter called “a document ID”) about the original electronic document of an image printed on the medium and information (hereinafter called “print information”) about printing of the electronic document.

The information separation part 23 separates information passed from the correspondence information management part 21 into information necessary to generate a document image and information necessary to generate a code image.

Based on the information necessary to generate the document image separated by the information separation part 23, the document image generation part 24 images an electronic document and stores the electronic document in the document image buffer 25.

Based on the information necessary to generate the code image separated by the information separation part 23, the code image generation part 26 generates a code image and stores the code image in the code image buffer 27.

The image combination part 28 combines the document image stored in the document image buffer 25 with the code image stored in the code image buffer 27.

The sending part 20b sends instructions to output an image after the combination by the image combination part 28 to the image formation apparatus 400 as a PDL (Page Description Language) typified by PostScript etc.

The position information encoding part 26a encodes position information by a predetermined encoding method. In this encoding, for example, a BCH code or an RS (Reed Solomon) code which is a known error-correcting code can be used. Also, as an error-detecting-code, a checksum value or a CRC (Cyclic Redundancy Check) of position information can be calculated to add it to the position information as a redundancy bit. Also, an M sequence code which is a kind of pseudo-noise sequence can be used as the position information. In the M sequence code, encoding is performed using a property in which a bit pattern generated in a partial sequence is generated in an M sequence only once when a partial sequence of a length P is fetched from an M sequence for an M sequence of P order (sequence length 2^{P-1}).

The position code generation part 26b converts the encoded position information into a format embedded as code information. For example, arrangement of each bit in the encoded position information can be encrypted or replaced by pseudo-random numbers etc. so that decryption by a third person becomes difficult. Also, when a position code is arranged in two dimensions, a bit value is arranged in two dimensions in a manner similar to arrangement of the code.

The identification information encoding part 26c encodes identification information by a predetermined encoding method when the identification information is inputted. In this encoding, a method similar to that used in encoding of the position information can be used.

The identification code generation part 26d converts the encoded identification information into a format embedded as code information. For example, arrangement of each bit in the encoded identification information can be encrypted or replaced by pseudo-random numbers etc. so that decryption by a third person becomes difficult. Also, when an identification code is arranged in two dimensions, a bit value is arranged in two dimensions in a manner similar to arrangement of the code. Incidentally, this identification code generation part 26d can also be grasped as a code information generation part from the standpoint of generating code information for uniquely identifying a medium.

The code arrangement part 26g combines the encoded identification information and the encoded position information arranged in the same format as that of the code, and generates a two-dimensional code array equivalent to an output image size. At this time, a code in which position information varying depending on an arrangement position is encoded is used as the encoded position information and a code in which the same information independently of a position is encoded is used as the encoded identification information.

The pattern image generation part 26i checks bit values of array elements in the two-dimensional code array, and acquires a bit pattern image corresponding to each of the bit values from the pattern storage part 26h, and outputs the bit pattern image as a code image in which the two-dimensional code array is imaged. Incidentally, this pattern image generation part 26i can also be grasped as a narrowly-defined code image generation part from the standpoint of generating a code image printed on a medium.

Incidentally, these function parts are implemented by cooperation between software and hardware resources. Specifically, a CPU (not shown) of the identification information management server 200 reads programs for implementing each of the functions of the receiving part 20a, the correspondence information management part 21, the information separation part 23, the document image generation part 24, the code image generation part 26, the image combination part 28 and the sending part 20b from an external storage device to a main storage device and performs processing.

Next, an action in the case that this identification information management server 200 sends instructions to output an image to the image formation apparatus 400 according to print instructions from the terminal apparatus 100 will be described.

Incidentally, here, the print instructions shall include identification information (hereinafter called “a print instructor ID”) about a print instructor in addition to a document ID, a print attribute. Also, in the embodiment, only when a person permitted to do printing inputs its user ID to the image formation apparatus 400 which receives the instructions to output an image, the actual printing can be done. Therefore, the print instructions shall also include identification information (hereinafter called “a specified printer ID”) about such a specified printer.

In the identification information management server 200, the receiving part 20a first receives the print instructions including the document ID, the print instructor ID and the specified printer ID from the terminal apparatus 100, and holds its receipt time as print instruction time. Then, received information and information about this print instruction time are passed to the correspondence information management part 21.

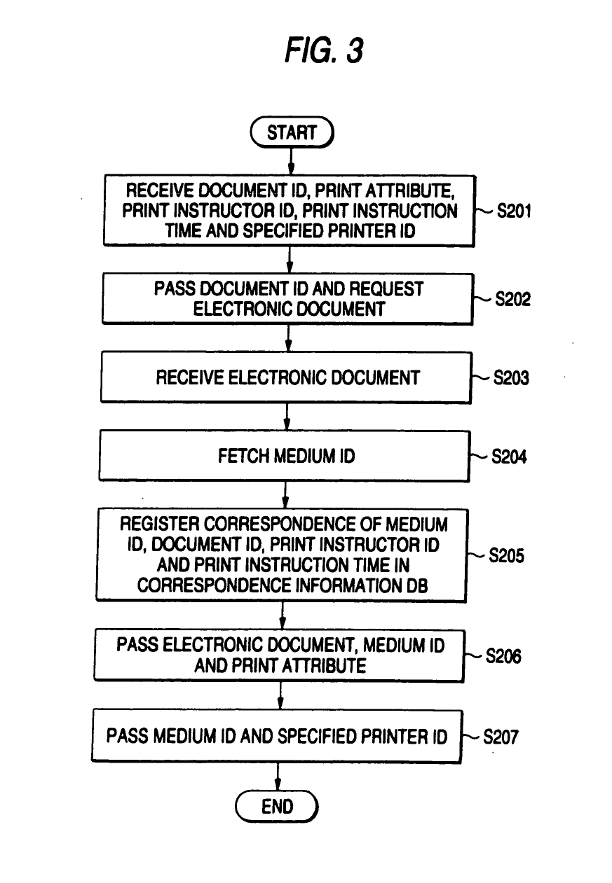

As a result of this, the correspondence information management part 21 performs processing as shown in FIG. 3.

That is, the document ID, the print attribute, the print instructor ID, the print instruction time and the specified printer ID are first received from the receiving part 20a (step 201). Next, the correspondence information management part 21 holds these information and also passes the document ID to the sending part 20b and instructs the sending part 20b to send an acquisition request for an electronic document corresponding to the document ID (step 202). The sending part 20b which receives this instruction requests sending of the electronic document from the document management server 300.

As a result of this, the document management server 300 sends an electronic document of a print target to the identification information management server 200 and in the identification information management server 200, the receiving part 20a receives this electronic document and passes the electronic document to the correspondence information management part 21.

Here, it again proceeds to processing of the correspondence information management part 21, and the correspondence information management part 21 receives the electronic document from the receiving part 20a (step 203). Also, identification information used as a medium ID is fetched from the identification information repository 250 (see FIG. 1) (step 204).

Then, the correspondence information management part 21 registers correspondence of the medium ID, the document ID, the print instructor ID and the print instruction time in the correspondence information DB 22 (step 205).

When the information is registered in the correspondence information DB 22 thus, the correspondence information management part 21 passes the electronic document, the medium ID and the print attribute to the information separation part 23 (step 206).

On the other hand, the correspondence information management part 21 passes the medium ID and the specified printer ID to the sending part 20b (step 207).

The information separation part 23 separates the passed information into information (medium ID and print attribute) necessary to generate a code and information (electronic document) necessary to generate a document image, and outputs the former to the code image generation part 26 and outputs the latter to the document image generation part 24.

As a result of this, position information corresponding to the print attribute is encoded in the position information encoding part 26a, and a position code indicating the encoded position information is generated in the position code generation part 26b. Also, the medium ID is encoded in the identification information encoding part 26c, and an identification code indicating the encoded medium ID is generated in the identification code generation part 26d.

Then, a two-dimensional code array equivalent to an output image size is generated by the code arrangement part 26g, and a pattern image corresponding to the two-dimensional code array is generated by the pattern image generation part 26i.

On the other hand, the document image generation part 24 generates a document image of the electronic document.

Then, the document image generated by this document image generation part 24 and the code image previously generated by the code image generation part 26 are finally combined by the image combination part 28 and are passed to the sending part 20b. As a result of this, the sending part 20b sends instructions to output an image after the combination to the image formation apparatus 400.

At that time, the sending part 20b also sends the medium ID and the specified printer ID passed in step 207 to the image formation apparatus 400.

According to the instructions to output the image, the image formation apparatus 400 prints the combined image of the code image and the document image of the electronic document of the print target on a medium, and a user obtains the printed matter 500.

Next, the image formation apparatus 400 will be described in detail.

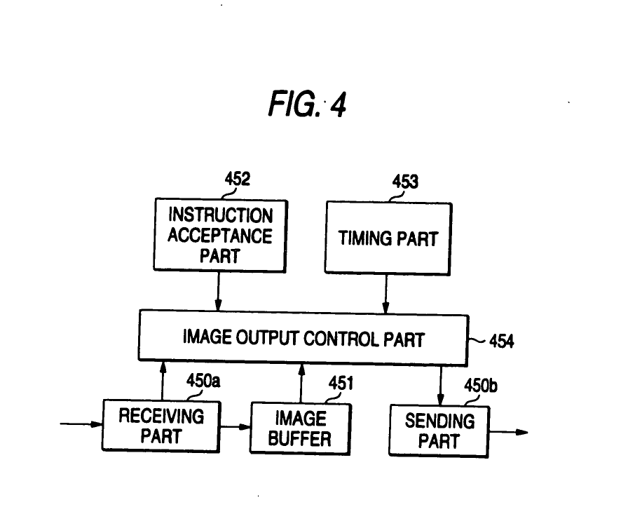

FIG. 4 is a diagram showing a functional configuration of a control part for performing image output control of the image formation apparatus 400.

The control part of the image formation apparatus 400 comprises a receiving part 450a, an image buffer 451, an instruction acceptance part 452, a timing part 453, an image output control part 454 and a sending part 450b.

The receiving part 450a receives various information about image output instructions etc. from the network 900.

The image buffer 451 is memory in which an image based on the image output instructions received by the receiving part 450a is temporarily stored. It is desirable that image data stored in the image buffer 451 be data of a state in which processing such as various image corrections or rasterizing is performed and printing can be started as soon as the image data is read out by the image output control part 454.

The instruction acceptance part 452 accepts print instructions inputted from, for example, a touch panel (not shown) of the image formation apparatus 400.

The timing part 453 is a timer for holding the present time.

According to instructions from the instruction acceptance part 452, the image output control part 454 outputs an image stored in the image buffer 451 to a body of the image formation apparatus 400 described below and monitors an action of its image output.

When the image output is normally ended, the sending part 450b acquires print time from the timing part 453 and sends out the print time to the network 900.

Next, an action of this image output control will be described.

In the image formation apparatus 400, the receiving part 450a first receives image output instructions including a medium ID and a specified printer ID. Then, the medium ID and the specified printer ID among these instructions are passed to the image output control part 454 and image data is stored in the image buffer 451.

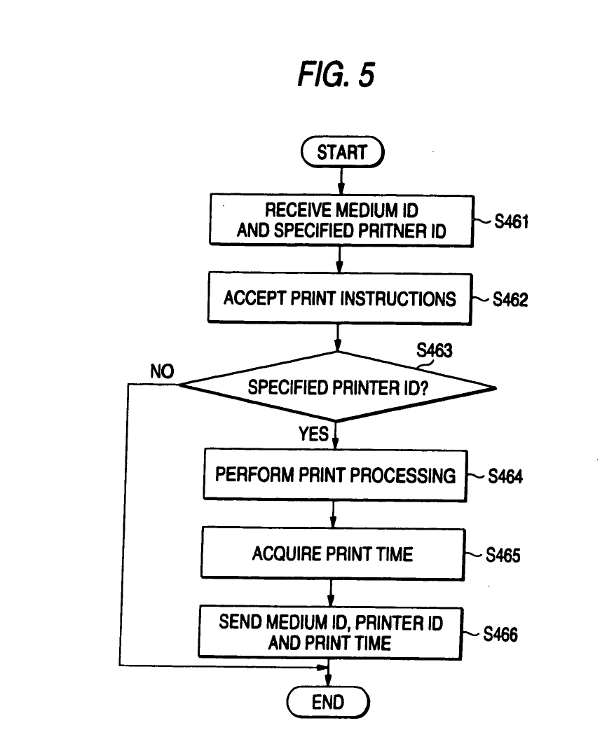

As a result of this, the image output control part 454 performs an action as shown in FIG. 5.

That is, the medium ID and the specified printer ID are first received from the receiving part 450a (step 461). Next, print instructions including a user ID are accepted from the instruction acceptance part 452 (step 462). Then, it is determined whether or not this user ID matches with the specified printer ID received in step 461 (step 463).

As a result of that, when the user ID does not match with the specified printer ID, for example, a message that “printing cannot be done since printing is not permitted” is displayed and processing is ended.

On the other hand, when the user ID matches with the specified printer ID, a body of the image formation apparatus 400 is instructed to perform print processing (step 464). Based on this instruction, in the body of the image formation apparatus 400, an image in which a code image is superimposed on an image of an electronic document is printed on a medium as described below. Then, when the printing is ended, the end of printing is reported to the image output control part 454.

As a result of this, the image output control part 454 acquires time (print time) at which the report of the end of printing is received from the timing part 453 (step 465). Then, the user ID (hereinafter called “a printer ID”) of a user checking that the user ID matches with the specified printer ID in step 463 and the print time acquired in step 465 are associated with the medium ID received in step 461 and are sent to the identification information management server 200 (step 466).

Here, a body of the image formation apparatus 400 will be described.

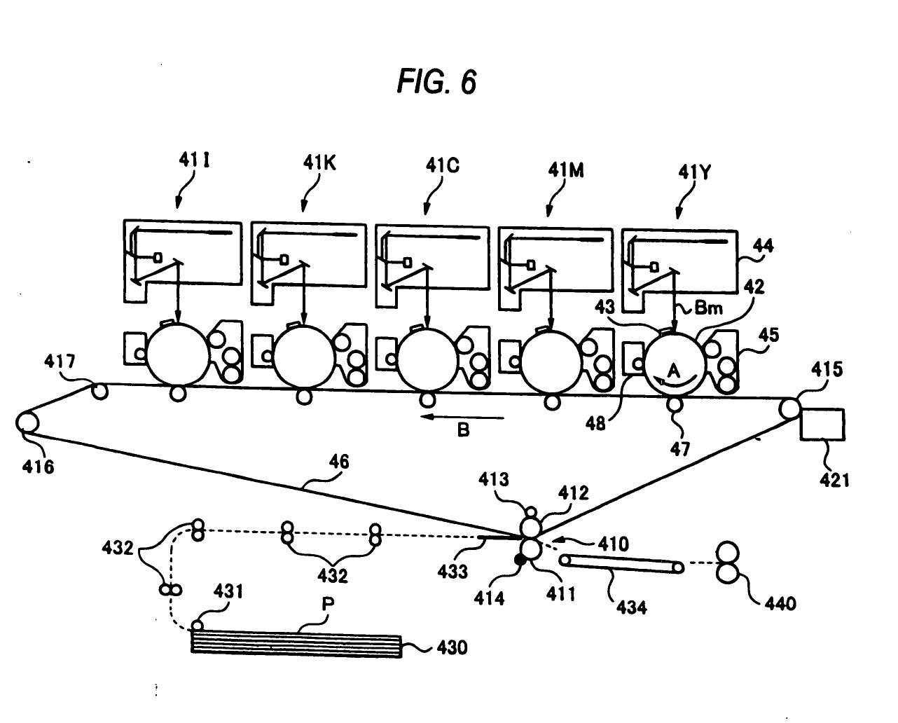

FIG. 6 is a diagram showing a configuration example of the body of the image formation apparatus 400. The image formation apparatus 400 shown in FIG. 6 is the so-called tandem type apparatus and comprises, for example, plural image formation units 41 (41Y, 41M, 41C, 41K, 41I) in which toner images of each of the color components are formed by an electrophotography method, an intermediate transfer belt 46 for sequentially transferring (primarily transferring) and holding the toner images of each of the color components formed by each of the image formation units 41, a secondary transfer device 410 for collectively transferring (secondarily transferring) an overlap image transferred on the intermediate transfer belt 46 on paper (medium) P, and a fixing device 440 for fixing the secondarily transferred image on the paper P.

In this image formation apparatus 400, the image formation unit 41K for forming a toner image of black (K) without having absorption in infrared light and the image formation unit 41I for forming an invisible toner image in addition to the image formation units 41Y, 41M, 41C for forming toner images of yellow (Y), magenta (M), cyan (C) which are regular use colors (normal colors) are disposed as one of the image formation units constructing a tandem.

Also, a color material with infrared absorption more than that of Y toner, M toner, C toner, K toner used in the image formation units 41Y, 41M, 41C, 41K is used in the image formation unit 41I. As such a color material, for example, a color material including vanadyl naphthalocyanine is given. Incidentally, for more ease of detection of a code image, a color material with infrared absorption less than that of a color material used in the image formation unit 41I is desirably used as K toner used in the image formation unit 41K, but a generally used color material (such as a color material including carbon) for absorbing infrared light can also be used.

In the embodiment, in each of the image formation units 41 (41Y, 41M, 41C, 41K, 41I), devices for electrophotography such as an electrification device 43 for electrifying a photoconductor drum 42, a laser exposure device 44 for writing an electrostatic latent image on the photoconductor drum 42 (showing an exposure beam by numeral Bm in the drawing), a developing device 45 for holding each color component toner and imaging the electrostatic latent image on the photoconductor drum 42 by the toner, a primary transfer roll 47 for transferring each color component toner image formed on the photoconductor drum 42 to the intermediate transfer belt 46 and a drum cleaner 48 for eliminating the residual toner on the photoconductor drum 42 are sequentially disposed in the periphery of the photoconductor drum 42 rotating in a direction of arrow A. These image formation units 41 are arranged in order of yellow (Y color), magenta (M color), cyan (C color), black (K color) and invisibility (I color) from the upstream side of the intermediate transfer belt 46.

Also, the intermediate transfer belt 46 is constructed rotatably in a direction of B shown in the drawing by various rolls. Various rolls have a driving roll 415 which is driven by a motor (not shown) and rotates the intermediate transfer belt 46, a tension roll 416 which gives constant tension to the intermediate transfer belt 46 and also has a function of preventing meandering of the intermediate transfer belt 46, an idle roll 417 for supporting the intermediate transfer belt 46, and a backup roll 412 (described below).

Also, it is constructed so that a voltage with polarity opposite to electrification polarity of toner is applied to the primary transfer roll 47 and thereby, it is constructed so that toner images on each of the photoconductor drums 42 are electrostatically sucked into the intermediate transfer belt 46 sequentially and an overlap toner image is formed on the intermediate transfer belt 46. Further, the secondary transfer device 410 comprises a secondary transfer roll 411 arranged in pressure contact with the side of a toner image carrying surface of the intermediate transfer belt 46, and the backup roll 412 which is arranged in the back side of the intermediate transfer belt 46 and forms an opposed electrode of the secondary transfer roll 411, and a metallic power feeding roll 413 to which a secondary transfer bias is stably applied is arranged in contact with this backup roll 412. Then, a brush roll 414 for eliminating dirt adhering to the secondary transfer roll 411 is arranged in contact with the secondary transfer roll 411.

Also, a belt cleaner 421 for cleaning a surface of the intermediate transfer belt 46 after the secondary transfer is disposed in the downstream side of the secondary transfer roll 411.

Further, as a paper transport system, the embodiment comprises a paper tray 430 for holding paper P, a pickup roll 431 for taking out the papers P stacked in this paper tray 430 at predetermined timing and transporting the papers P, a transport rolls 432 for transporting the paper P run out by the pickup roll 431, a transport chute 433 for feeding the paper P transported by the transport rolls 432 to a secondary transfer position by the secondary transfer device 410, and a transport belt 434 for transporting the paper P after the secondary transfer to the fixing device 440.

Next, an image formation process of this image formation apparatus 400 will be described. When a start switch (not shown) is turned on by a user, a predetermined image formation process is performed. Specifically, for example, when this image formation apparatus 400 is constructed as a color printer, digital image signals sent from the network 900 are temporarily accumulated in memory and based on the accumulated digital image signals of five colors (Y, M, C, K, I), toner images of each of the colors are formed.

That is, the image formation units 41 (41Y, 41M, 41C, 41K, 41I) are respectively-driven based on image record signals of each of the colors obtained by image processing. Then, in each of the image formation units 41Y, 41M, 41C, 41K, 41I, electrostatic latent images according to the image record signals are respectively written by the laser exposure devices 44 with respect to the photoconductor drums 42 uniformly electrified by the electrification devices 43. Also, each of the written electrostatic latent images is developed by the developing device 45 for holding toner of each color and a toner image of each color is formed.

Then, the toner image formed on each of the photoconductor drums 42 is primarily transferred from the photoconductor drum 42 to a surface of the intermediate transfer belt 46 by a primary transfer bias applied by the primary transfer roll 47 in a primary transfer position in which each of the photoconductor drums 42 makes contact with the intermediate transfer belt 46. The toner image primarily transferred to the intermediate transfer belt 46 thus is superimposed on the intermediate transfer belt 46 and is transported to a secondary transfer position with rotation of the intermediate transfer belt 46.

On the other hand, paper P is transported to a secondary transfer position of the secondary transfer device 410 at predetermined timing, and the secondary transfer roll 411 nips the paper P on the intermediate transfer belt 46 (backup roll 412). Then, an overlap toner image carried in the intermediate transfer belt 46 is secondarily transferred to the paper P by action of a secondary transfer electric field formed between the secondary transfer roll 411 and the backup roll 412.

Thereafter, the paper P to which the toner image is transferred is transported to the fixing device 440 by the transport belt 434, and the toner image is fixed. On the other hand, in the intermediate transfer belt 46 after the secondary transfer, the residual toner is eliminated by the belt cleaner 421.

Next, an action of the identification information management server 200 which receives a medium ID, a printer ID and print time from the image formation apparatus 400 will be described.

In the identification information management server 200, the receiving part 20a first receives the medium ID, the printer ID and the print time from the image formation apparatus 400. Then, received information is passed to the correspondence information management part 21.

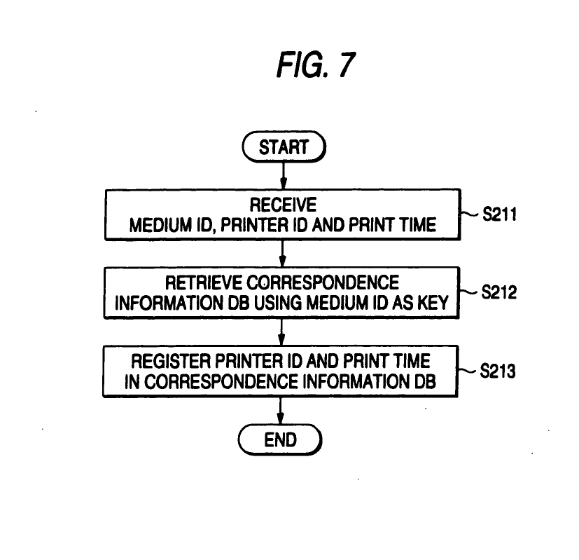

As a result of this, the correspondence information management part 21 performs processing as shown in FIG. 7.

That is, the medium ID, the printer ID and the print time are first received from the receiving part 20a (step 211). Next, information is retrieved from the correspondence information DB 22 using the medium ID as a key (step 212). Then, the printer ID and the print time received in step 211 are written into the information and the correspondence information DB 22 is updated (step 213).

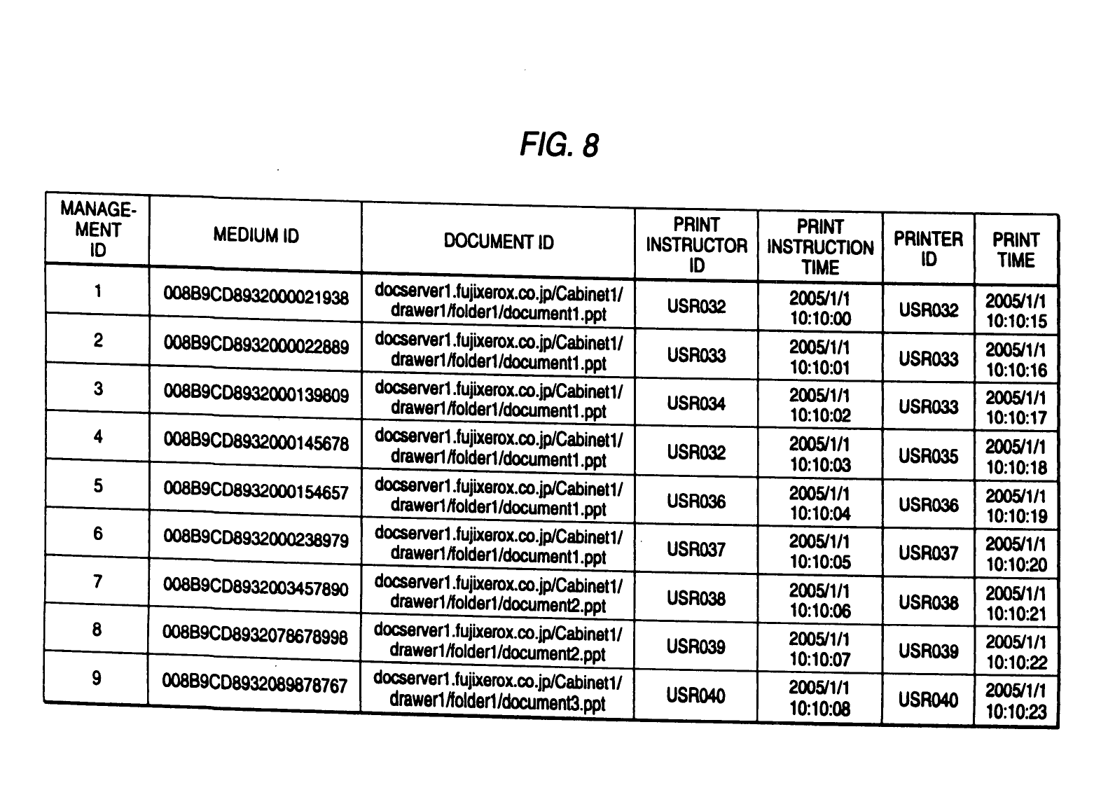

FIG. 8 is a diagram showing the contents of the correspondence information DB 22 at this time.

As shown in the diagram, in the correspondence information DB 22, a management ID, a medium ID, a document ID, a print instructor ID, print instruction time, a printer ID and print time are associated and managed.

Here, the medium ID is information for uniquely identifying a medium on which an electronic document is printed as described above. When a medium is managed by the identification information management server 200, information fetched from among identification information managed so as to become unique in the identification information repository 250 could be used as the medium ID. On the other hand, when a medium is managed by the image formation apparatus 400, for example, it is contemplated to generate the medium ID based on identification information about the image formation apparatus 400 and identification information about a medium printed by the image formation apparatus 400. Among these, the identification information about the medium printed by the image formation apparatus 400 includes information about print time or print order. Also in FIG. 8, the medium ID is generated by combining “008B9CD8932” which is the identification information about the image formation apparatus 400 with the identification information about the medium subsequent to that.

The document ID is information for uniquely identifying an electronic document as described above, and a URL (Uniform Resource Locator) of the electronic document is illustrated as shown in the diagram.

Identification information about a user who gives instructions to print is stored as the print instructor ID, and time at which the instructions to print are given is stored as the print instruction time.

Also, identification information about a user who actually does printing by the image formation apparatus 400 is stored as the printer ID, and time at which the printing was done is stored as the print time.

Incidentally, in a line of “3” of the management ID, the print instructor ID is “USR034” and the printer ID is “USR033” and both the IDs differ. Also, in a line of “4” of the management ID, the print instructor ID differs from the printer ID. These are an example of the case that when instructions to print are given from the terminal apparatus 100, a print instructor specifies a third person other than oneself as a person permitted to do actual printing and the permitted person did the printing as described above.

However, particularly in such a case, a situation in which information about instructions to print is registered but information about actual printing is not registered may occur. This is the case that actual printing is not done and is left though instructions to print are given, and it is necessary to urge the printing. That is, information managed in the embodiment can also be used in processing for urging the printing with respect to the print instructions in which the printing is not done and is left.

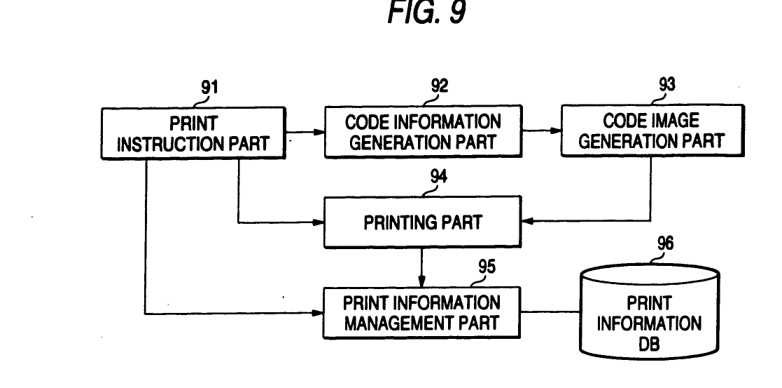

By the way, the embodiment can also be grasped as a system configuration as shown in FIG. 9.

That is, the present system comprises a print instruction part 91, a code information generation part 92, a code image generation part 93, a printing part 94, a print information management part 95 and a print information DB 96.

Here, the print instruction part 91 is a part for instructing the printing part 94 to print an electronic document, and corresponds to the terminal apparatus 100 of FIG. 1.

The code information generation part 92 is a part for generating code information for uniquely identifying a medium, and the code image generation part 93 is a part for generating a code image from this code information. These parts are set as a function of the identification information management server 200 in FIG. 1, but may be set as a function of the image formation apparatus 400.

The printing part 94 is a part for printing an image in which the code image is superimposed on an image of the electronic document on a medium, and corresponds to the image formation apparatus 400 of FIG. 1.

The print information management part 95 is a part for associating information about print instructions sent from the print instruction part 91 or information about printing sent from the printing part 94 with the code information and managing the information, and the print information DB 96 is a database for storing these information. Such an information management function may be implemented by any of the identification information management server 200, the image formation apparatus 400 and the terminal apparatus 100, or may be implemented by other apparatus. Also, in FIG. 2, an item of print information is added to the print information DB 96 for associating identification information about the medium with identification information about the electronic document and managing the identification information, but it may be constructed so as to associate identification information about the medium with only print information and manage the information as shown in the print information DB 96 of FIG. 9.

Incidentally, the embodiment has been constructed so as to manage only identification information about the electronic document as information about the electronic document, but identification information etc. about a creator of the electronic document may be used. Incidentally, the information about the electronic document may also be grasped as information obtained in the case of acquiring the electronic document.

The embodiment has been constructed so as to manage identification information about a person who gives instructions to print the electronic document, time at which the instructions to print are given, identification information about a person who prints the electronic document and time at which the printing is done as information about printing of the electronic document, but it is not limited to these. It may be constructed so as to manage any information as long as the information is information obtained in the case of printing the electronic document.

According to an aspect of the invention, it may become possible to later trace various information about an electronic document or various information obtained at the time of printing its electronic document while individual management of media on which the electronic document is printed may be performed.

As described above, the embodiment has been constructed so as to associate various information (meta-information) about an electronic document or printing of the electronic document with a medium on which the electronic document is printed and manage the information. As a result of this, it may be possible to later trace various information about an electronic document or various information obtained at the time of printing its electronic document while individual management of media on which the electronic document is printed may be performed.

The entire disclosure of Japanese Patent Application No. 2005-203133 filed on Jul. 12, 2005 including specification, claims, drawings and abstract is incorporated herein by reference in its entirety.

The foregoing description of the embodiments of the present invention has been provided for the purposes of illustration and description. It is not intended to be exhaustive or to limit the invention to the precise forms disclosed. Obviously, many modifications and variations will be apparent to practitioners skilled in the art. The embodiments were chosen and described in order to best explain the principles of the invention and its practical applications, thereby enabling others skilled in the art to understand the invention for various embodiments and with the various modifications as are suited to the particular use contemplated. It is intended that the scope of the invention be defined solely by the following claims and their equivalents.

1. A printing apparatus comprising:
an electronic document acquisition part that acquires an electronic document of a print target;
a code information generation part that generates code information for uniquely identifying a medium on which a document image of the electronic document is printed;
a code image generation part that generates a code image for printing from the code information generated by the code information generation part;
a document image generation part that generates the document image from the electronic document;
a printing part that prints the generated code image using an invisible toner and the document image using a visible toner on the medium; and
a management part that associates at least one of information obtained when acquiring the electronic document and information obtained when printing the electronic document with the code information, the management part managing the information.

2. A printing apparatus as claimed in claim 1, wherein the code information generation part generates the code information based on identification information regarding a user and at least one of information regarding print time and print order.

3. A printing apparatus as claimed in claim 1, wherein the management part manages at least one of identification information about the electronic document and identification information about a creator of the electronic document.

4. A printing apparatus as claimed in claim 1, wherein the management part manages at least one of identification information about a person who gives instructions to print the electronic document and information about time at which the instructions to print are given.

5. A printing apparatus as claimed in claim 4, wherein the printing part prints the code image and the document image on the medium when the instructions to print given to the printing part are proper, and the management part manages at least one of identification information about a person who gives the instructions to print and information about time at which the instructions to print are given when printing is done by the printing part.

6. An information management apparatus comprising:
a receiving part that receives instruction to print in a terminal apparatus of an electronic document;
a code information generation part that generates code information that uniquely identifies a medium on which a document image of the electronic document is printed;
a code image generation part that generates a code image that prints from the code information generated by the code information generation part;
a document image generation part that generates the document image from the electronic document;
a sending part that sends instruction to print the generated code image using an invisible toner and the document image using a visible toner on the medium to a printing apparatus; and
a management part that associates at least one of information obtained when acquiring the electronic document and information obtained when printing the electronic document with the code information, the management part managing the information.

7. An information management apparatus as claimed in claim 6, wherein the management part manages at least one of identification information about the electronic document, identification information about a creator of the electronic document, identification information about a person who gives instructions to print in the terminal apparatus and information about time at which the instructions to print are given.

8. An information management apparatus as claimed in claim 6, wherein the receiving part receives at least one of identification information about a person who gives instructions to print in the printing apparatus and information about time at which the instructions to print are given, and the management part manages at least one of information about time and identification information received by the receiving part.

9. A print processing method comprising:
giving instruction to print an electronic document;
generating code information that uniquely identifies a medium on which a document image of the electronic document is printed;
generating a code image that prints from the generated code information;
generating the document image from the electronic document;
printing the generated code image using an invisible toner and the document image using a visible toner on the medium; and
associating at least one of information obtained when acquiring the electronic document and information obtained when printing the electronic document with the code information and managing the information.

10. A storage medium readable by a computer, the storage medium storing a program of instructions executable by the computer to perform a function, comprising:
receiving instructions to print an electronic document;
generating code information that uniquely identifies a medium on which a document image of the electronic document is printed;
generating a code image that prints from the generated code information;
generating the document image from the electronic document;
sending instruction to print the generated code image using an invisible toner and the document image using a visible toner on the medium; and
associating at least one of information obtained when acquiring the electronic document and information obtained when printing the electronic document with the code information and managing the information.
